(19) United States
(12) Patent Application Publication
(10) Pub. No.: US 2017/0167666 A1
(43) Pub. Date: Jun. 15, 2017

(54) OPTICAL ELEMENT AND ILLUMINATION APPARATUS

(71) Applicants: Kabushiki Kaisha Toshiba, Minato-ku (JP); Toshiba Materials Co., Ltd., Yokohama-shi (JP)

(72) Inventors: Hiroshi OHNO, Yokohama (JP); Mitsuaki KATO, Kawasaki (JP); Hiromichi HAYASHIHARA, Saitama (JP); Hiroyasu KONDO, Yokohama (JP); Ryoji TSUDA, Fujisawa (JP); Yasumasa OOYA, Chigasaki (JP)

(73) Assignees: Kabushiki Kaisha Toshiba, Minato-ku (JP); Toshiba Materials Co., Ltd., Yokohama-shi (JP)

(21) Appl. No.: 15/445,180

(22) Filed: Feb. 28, 2017

Related U.S. Application Data
(63) Continuation of application No. PCT/JP2014/076140, filed on Sep. 30, 2014.

(51) Int. Cl. F21K 9/61; F21K 9/232; F21K 9/235; F21K 9/69

(52) U.S. Cl. CPC F21K 9/61; F21K 9/69; F21K 9/232; F21K 9/235

(57) ABSTRACT

An optical element according to an embodiment is formed from a material transparent to visible light and has a rotationally symmetrical shape with respect to the central axis. A cavity containing no transparent material is provided inside the optical element. The inner surface of the cavity has a shape in which a boundary line of the cavity along which a plane including the central axis intersects the inner surface includes a curve portion expanding toward the outside of the optical element. The inner surface of the cavity does not include any surface recessed inwardly.

### CROSS-REFERENCE TO RELATED APPLICATION

This application is a Continuation Application of PCT Application No. PCT/JP2014/076140, filed Sep. 30, 2014, the entire contents of all of which are incorporated herein by reference.

FIELD

Embodiments described herein relate generally to an illumination apparatus used for homes, shops, offices, and the like and an optical element incorporated in the illumination apparatus.

### BACKGROUND

Some LED illumination apparatuses for general illumination are sometimes required to be approximated to the shape of an incandescent light bulb and the way in which it shines (retrofitting). In particular, there is great demand for a technique of making a point light source inside a globe emit light with a wide light distribution (½ distribution angle: about 270°) like a clear incandescent light bulb (an incandescent light bulb using a clear glass globe). If, however, an LED is used as a light source without any change, the distribution angle becomes narrow, and the ½ distribution angle becomes about 120°. Attempts therefore have been made to achieve an increase in distribution angle by using an optical element such as a wide light distribution lens or the like.

As this type of optical element, for example, an element having a scattering member on a distal end of a light guide rod is known. When this optical element is used, the LED is arranged facing the bottom surface of the light guide rod facing the scattering member at a distance. A light beam emitted from the LED propagates by total reflection in the light guide rod to be guided to the scattering member. Each light beam reaching the scattering member is scattered by the scattering member to emerge to the outside of the optical element. In this manner, a light beam group with a wide light distribution is generated.

When, however, the above optical element is used, several light beams of a light beam group scattered by the scattering member propagate in the light guide rod again and return to the LED. The light beams which have returned to the LED are almost totally absorbed. That is, as the ratio of light beams that return to the LED increases, the loss of light beams increases, resulting in a reduction in light output ratio.

Therefore, there is a demand for the development of an optical element which can efficiently cause light with a wide light distribution to emerge and an illumination apparatus including the optical element.

### BRIEF DESCRIPTION OF THE DRAWINGS

FIG. 1 is a perspective view showing the outer appearance of an optical element according to the first embodiment;

FIG. 2 is a partially enlarged sectional view of the main part of the optical element in FIG. 1;

FIG. 3 is a view showing a simulation result on the light distribution of the optical element in FIG. 1;

FIG. 4 is an external view showing an optical element according to the second embodiment;

FIG. 5 is a partially enlarged sectional view of the main part of the optical element in FIG. 4;

FIG. 6 is a schematic view showing an illumination apparatus including the optical element in FIG. 4;

FIG. 7 is an external view showing an optical element according to the third embodiment;

FIG. 8 is a sectional view taken along a plane including the central axis of the optical element in FIG. 7;

FIG. 9A is an external view showing an optical element according to the fourth embodiment; and

FIG. 9B is a bottom view showing the optical element in FIG. 9A.

### DETAILED DESCRIPTION

Embodiments will be described below with reference to the accompanying drawings.

An optical element according to an embodiment is formed from a material transparent to visible light and has a rotationally symmetrical shape with respect to the central axis. A cavity containing no transparent material is provided inside the optical element. The inner surface of the cavity has a shape in which a boundary line of the cavity along which a plane including the central axis intersects the inner surface includes a curve portion expanding toward the outside of the optical element. In addition, when an origin is set in the cavity, a clockwise direction around the origin along the boundary line is set as a positive direction, a first tangent vector is set at a first point on the boundary line, and a second tangent vector is set at a second point adjacent to the first point in the positive direction, an angle defined by the second tangent vector with respect to the first tangent vector with the clockwise direction being a positive direction is not less than 0°. The inner surface of the cavity does not include any surface recessed inwardly.

### First Embodiment

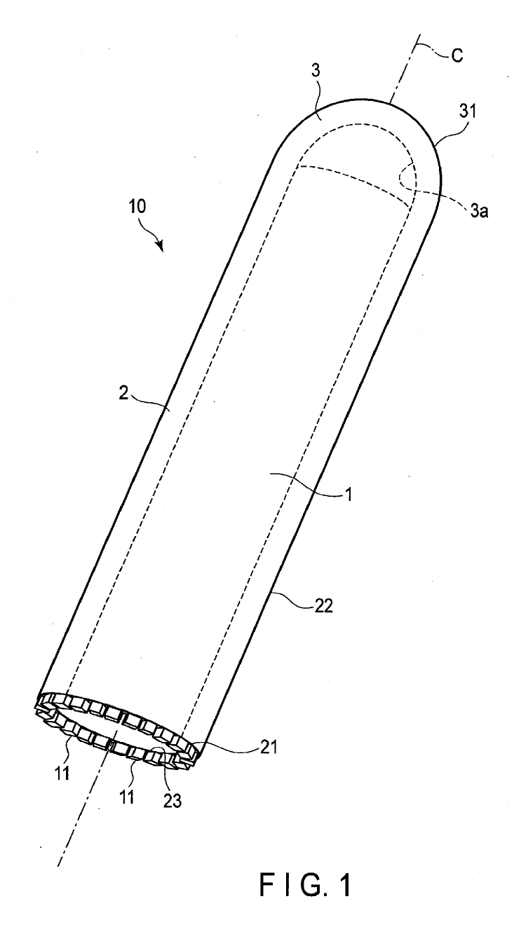

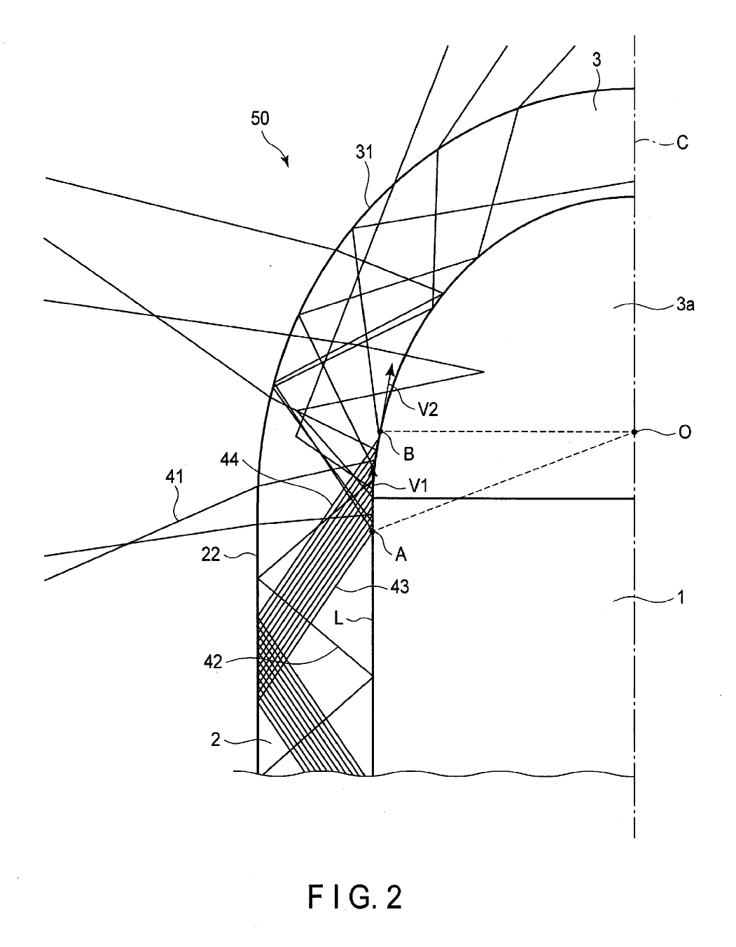

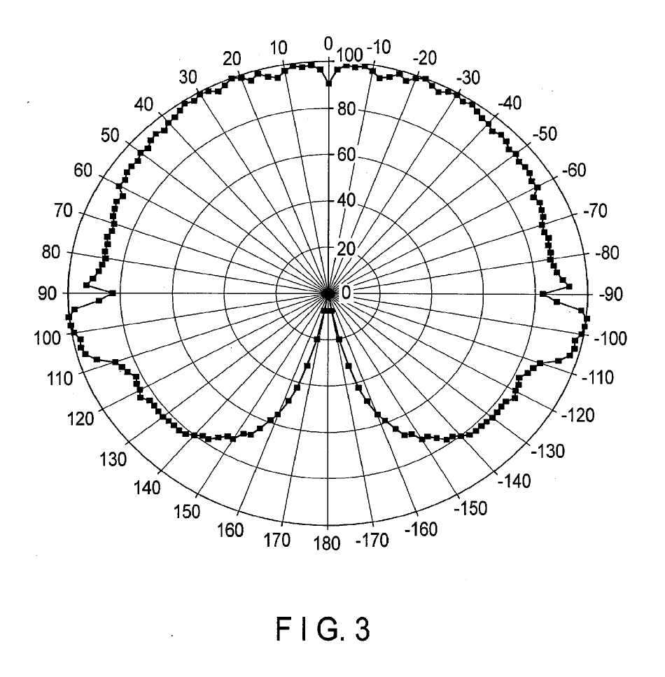

FIG. 1 is a perspective view showing the outer appearance of an optical element 10 according to the first embodiment. FIG. 2 is a partially enlarged sectional view of the optical element 10 in FIG. 1 taken along a plane including a central axis C of the element. FIG. 3 is a radar chart showing a calculation result obtained by simulation on the light distribution of the optical element 10 in FIG. 1. FIG. 1 also shows, in addition to the optical element 10, a plurality of light-emitting elements 11 facing one end (the lower end in FIG. 1) of the optical element 10 in the longitudinal direction. Each light-emitting element 11 is obtained by, for example, sealing an LED chip (not shown) with a resin.

As shown FIG. 1, the optical element 10 is a rotating body having a rotationally symmetrical shape with respect to the central axis C. The optical element 10 is formed from a material transparent to visible light (acrylic in this embodiment). Any material that is transparent to visible light can be used for the optical element 10. The optical element 10 may be formed from, for example, polycarbonate or glass instead of acrylic.

In addition, the optical element 10 includes a cavity 1 which does not contain the above transparent material. In this embodiment, the cavity 1 also has a rotationally symmetrical shape with respect to the central axis C. In addition, the cavity 1 in the embodiment is provided throughout almost the entire length of the optical element 10 in the longitudinal direction.

That is, the optical element 10 has a structure with a cylindrical light guide portion 2 and a hemispherical scattering portion 3 being integrally connected to each other. The light guide portion 2 has the same outer diameter as the scattering portion 3. The cylindrical inside of the light guide portion 2 is smoothly connected to the hollow inside of the scattering portion 3 to form the cavity 1. That is, the cavity 1 in this embodiment is a space having a shape with one end of a cylinder (the upper end in FIG. 1) and a hemisphere having the same diameter as that of the cylinder being connected to each other. In other words, the cavity 1 extends into the inside of the scattering portion 3 through the entire length of the light guide portion 2.

Of the inner surface of the cavity 1, the inner surface (hemispherical surface) of the scattering portion 3 is a diffusing surface 3a which scatters light. The inner surface (i.e., the cylindrical surface) of the cavity 1 except for the diffusing surface 3a is a mirror surface. Forming the inner surface of the scattering portion 3, provided near the distal end of the optical element 10, into the diffusing surface 3a in this manner enables light with a wide distribution angle to emerge.

The diffusing surface 3a located on the inner side of the scattering portion 3 may be obtained by, for example, covering the inner surface of the cavity 1 with a white coating. Alternatively, the diffusing surface 3a may be a rough surface obtained by partially sandblasting the inner surface of the cavity 1. Alternatively, instead of providing the diffusing surface 3a, the cavity 1 of the scattering portion 3 may be filled with a scattering member (not shown) which scatters light.

Note that the diffusing surface 3a may extend to a position slightly entering the cylindrical inner surface of the light guide portion 2. When the cavity 1 is to be filled with a scattering member, the cavity may be filled with the member up to a position slightly entering the inside of the light guide portion 2. That is, the size of the diffusing surface 3a can be arbitrarily changed.

The light guide portion 2 has a bottom surface 21 having a circular rim on one end side in the longitudinal direction, which is separated from the scattering portion 3 along the central axis C. The light guide portion 2 also has a cylindrical side surface 22 continuously extending from the rim of the bottom surface 21 to the other end side in the longitudinal direction. A hemispherical surface 31, which is the outer surface of the scattering portion 3, gently continues on the other end side remote from the bottom surface 21 of the side surface 22.

That is, the bottom surface 21, the side surface 22, and the hemispherical surface 31 constitute the outer surface of the optical element 10. All these surfaces are mirror surfaces. However, this is not exhaustive. The surfaces 21, 22, and 31 may include diffusing surfaces. Note that the bottom surface 21 is perpendicular to the central axis C of the optical element 10, and the side surface 22 extends parallel to the central axis C.

One end (the lower end in FIG. 1) of the cavity 1 is connected to the bottom surface 21 to form a circular opening 23 concentric to the bottom surface 21. The inner surface of the cavity 1 has a shape expanding toward the bottom surface 21 along the central axis C. In this case, assume that an expanding shape indicates a shape other than a narrowing shape and includes a shape like a cylindrical surface. That is, since the inner surface (diffusing surface 3a) of the scattering portion 3 is a hemispherical surface, the cavity 1 has a shape including no internally recessed surface.

Note that the above expression “rotationally symmetrical” means that when an object is rotated about the central axis C, the object coincides with the original shape, and the rotation angle about the central axis C becomes less than 360°.

The plurality of light-emitting elements 11 each have a light-emitting surface (not shown). Each light-emitting element 11 is arranged such that the light-emitting surface faces the annular bottom surface 21 of the optical element 10. In this embodiment, the plurality of light-emitting elements 11 are annularly arranged at equal intervals in the circumferential direction of the bottom surface 21. Note that in this case, for example, the plurality of light-emitting elements 11 are mounted on the surface of a substrate (not shown). In the embodiment, the plurality of light-emitting elements 11 are arranged on the same plane. However, this is not exhaustive. The plurality of light-emitting elements 11 may be three-dimensionally arranged.

The inner surface shape of the cavity 1 described above will be described in more detail below with reference to FIG. 2. Note that FIG. 2 is an enlarged view of a portion (near the diffusing surface 3a) of a section of the optical element 10 taken along a plane including the central axis C.

The cavity 1 in this embodiment has a rotationally symmetrical shape with respect to the central axis C. For this reason, when the optical element 10 is cut along a plane including the central axis C, the shape of a line L (to be referred to as the boundary line L hereinafter) along which the cut plane intersects the inner surface of the cavity 1 uniquely represents the inner surface shape of the cavity 1. That is, defining the shape of the boundary line L can define the inner surface of the cavity 1.

The boundary line L includes a curve portion with its shape expanding toward the outside of the optical element 10. In this embodiment, a line along which the inner surface (diffusing surface 3a) of the scattering portion 3 intersects the cut plane is a curve portion. The boundary line L also includes a straight line along which the inner surface of the light guide portion 2 intersects the cut plane. In other words, the boundary line L does not have any portion which is internally recessed toward the cavity 1.

For example, on the section in FIG. 2, an origin O is set inside the cavity 1, and a direction clockwise in FIG. 2, around the origin O along the boundary line L is defined as a positive direction. The origin O can be an arbitrary point inside the cavity 1, other than on the inner surface. Assume that in this case, the origin O is set at the center of the curvature of the scattering portion 3 on the central axis C.

Subsequently, an arbitrary point A is set on the boundary line L, and a tangent at the point A is defined as a tangent vector V1 facing in the positive direction. As described above, the positive direction is defined as the direction clockwise around the origin O on the boundary line L. In addition, a point B is set, which has moved from the point A in the positive direction on the boundary line L, and a tangent at the point B is defined as a tangent vector V2 facing in the positive direction. Assume that in this case, the angle defined by the tangent vector V2 with respect to the tangent vector V1 with the above clockwise direction being the positive direction is a tangent rotation angle θ.

Defining the boundary line L based on the above conditions can form a shape with the tangent rotation angle θ being always 0° or more.

The function of the optical element 10 will be described next.

Light emitted from the plurality of light-emitting elements 11 (FIG. 1) propagates in the optical element 10 as shown in FIG. 2. Light emerging from each optical element 10 can be classified as a group of light beams parallel to each other. For this reason, a light beam group will be discussed below without losing generality.

A light beam group emitted through the light-emitting surface of each light-emitting element 11 enters the bottom surface 21 of the optical element 10. The light beam group which has entered the optical element 10 from the bottom surface 21 is guided while being repeatedly totally reflected between the side surface 22 of the light guide portion 2, the hemispherical surface 31 of the scattering portion 3, and the inner surface of the cavity 1.

In this case, a light beam group scattered (primary scattering) by the diffusing surface 3a which is included by the inner surface of the cavity 1 includes transmission and reflection components that vary depending on the incident angle of the light beam group with respect to the diffusing surface 3a. That is, as the incident angle with respect to the diffusing surface 3a increases, the reflection component (diffuse reflection component) increases, and the transmission component (diffuse transmission component) decreases. In contrast to this, as the incident angle with respect to the diffusing surface 3a decreases, the reflection component decreases, and the transmission component increases. In this case, the incident angle indicates the angle defined by the normal direction of the diffusing surface 3a and an incident light beam at a point where the light beam entering the diffusing surface 3a strikes the diffusing surface 3a.

In contrast to this, if the cavity 1 is filled with a scattering member without providing the inner surface of the scattering portion 3 with the diffusing surface 3a, the transmission component of a light beam transmitted through the inner surface of the scattering portion 3 becomes an absorption component, but the reflection component remains the same. That is, in either of the above cases, as the incident angle of a light beam with respect to the inner surface of the cavity 1 increases, the reflection component increases, and vice versa.

A light beam reflected by the inner surface of the cavity 1 is refracted and transmitted to the outside from the side surface 22 or the hemispherical surface 31 of the optical element 10, or is reflected again by the side surface 22 or the hemispherical surface 31 and returned to the diffusing surface 3a. The light beam returned to the diffusing surface 3a is scattered again (secondary scattering) by the diffusing surface 3a. However, part of the light beam scattered by the diffusing surface 3a is returned to the light guide portion 2.

Referring to FIG. 2, for example, a light beam 41 is an example of a light beam refracted and transmitted from the side surface 22, and a light beam 42 is an example of a light beam returned to the light guide portion 2. The light beam 42 returning to the light guide portion 2 finally returns to the light-emitting element 11 to be absorbed. In contrast, most of light beams secondarily scattered by the diffusing surface 3a are finally refracted and transmitted through the side surface 22 of the optical element 10. It is therefore possible to reduce light beams returning to the light-emitting elements 11 and absorbed by them by preventing light beams primarily diffused and reflected by the diffusing surface 3a from returning to the light guide portion 2 and making the diffusing surface 3a scatter the light beams again.

In order to increase the light output ratio of the optical element 10 of this type, it is desirable to minimize light beams scattered by the diffusing surface 3a and returning to the light guide portion 2. Light beams returning to the light guide portion 2 may be reduced by setting a state in which light primarily reflected by the diffusing surface 3a easily enters the diffusing surface 3a again. To set such a state, light beams may be scattered by regions, of all the regions of the diffusing surface 3a, which are as far as possible from the light-emitting elements 11.

Most of light beams scattered by regions as far as possible from the light-emitting elements 11 are refracted and transmitted through the hemispherical surface 31 of the scattering portion 3 or the side surface 22 of the light guide portion 2. Some light beams which are not refracted and transmitted do not directly return to the light guide portion 2 and tend to enter the diffusing surface 3a again. As described above, most of the light beams which are secondarily scattered by the diffusing surface 3a are refracted and transmitted finally through the side surface 22 of the optical element 10.

In contrast to this, if many light beams are scattered by regions close to the light-emitting elements 11, the primarily scattered light tends to return to the light guide portion 2, and finally tends to be absorbed by the light-emitting elements 11.

The optical element 10 according to the first embodiment described above has an arrangement configured to cause many light beams emitted from the light-emitting elements 11 to be scattered by regions as far as possible from the light-emitting elements 11. The function of this arrangement will be described below with reference to FIG. 2.

Of a parallel light group emitted from the light-emitting element 11, a light beam 43 is diffused and reflected at the point A on the inner surface of the cavity 1, and a light beam 44 is diffused and reflected at the point B in the same manner. At this time, the light beam 43 incident at the point A and the light beam 44 incident at the point B differ in incident angle with respect to the inner surface of the cavity 1.

As described above, in this embodiment, since the tangent rotation angle θ defining the inner surface shape of the cavity 1 (the shape of the boundary line L) is always 0° or more, the incident angle of the light beam 44 with respect to the point B is larger than the incident angle of the light beam 43 with respect to the point A in FIG. 2. That is, in this case, the diffuse reflection component of the light beam 44 at the point B is larger than the diffuse reflection component of the light beam 43 at the point A.

From another point of view, in this embodiment, in order to increase the diffuse reflection component of a light beam at a region as far as possible from the light-emitting element 11, the inner surface shape of the cavity 1 is formed so as to make the tangent rotation angle θ be always 0° or more. This can reduce a light beam returning to the light-emitting element 11 and increase the light output ratio of the optical element 10.

In addition, since the tangent rotation angle continuously changes along the boundary line L or is constant, it is possible to gently change the direction of diffuse reflection. This makes it possible to obtain a gentle light distribution like that of an incandescent light bulb.

The light distribution of the optical element 10 described above can be calculated by using a ray tracing simulation (LightTools®). FIG. 3 shows a calculation result. FIG. 3 shows the luminous intensities of light beams corresponding to distribution angles in a radar chart form. As is obvious from FIG. 3, in the case of the optical element 10 according to this embodiment, the ½ distribution angle is about 310°, which exceeds 300°.

As described above, this embodiment can provide the optical element 10 which can efficiently cause light with a wide light distribution to emerge in spite of using an LED as a light source.

### Second Embodiment

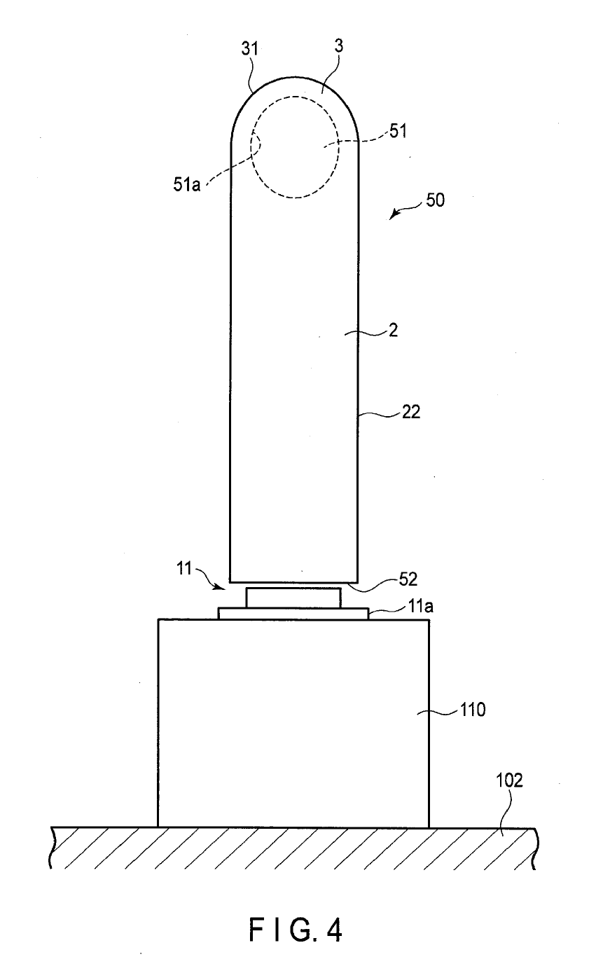

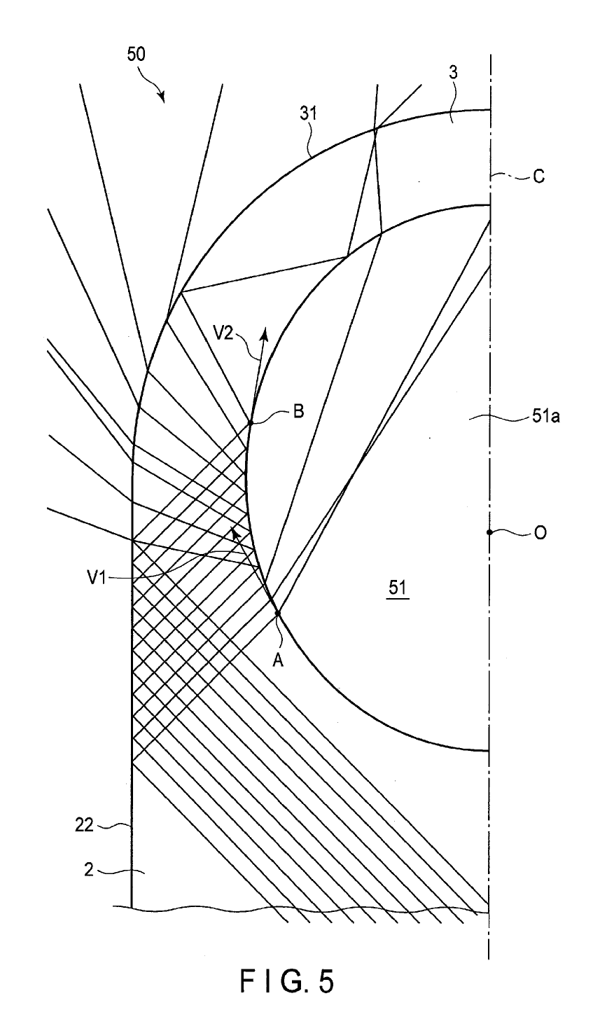

An optical element 50 according to the second embodiment will be described next with reference to FIGS. 4 and 5. The optical element 50 has a cavity 51 which does not communicate with a bottom surface 52 of the optical element 50. An enclosed space is formed inside the optical element 50. Other arrangements are almost the same as those according to the first embodiment described above. In this case, therefore, the same reference numerals denote constituent elements having the same functions as those in the first embodiment, and a detailed description of them will be omitted.

The inner surface shape of the cavity 51 of the optical element 50 is an ellipsoid of revolution formed with reference to two fixed points (not shown) separated from each other on a central axis C. That is, the inner surface of the cavity 51 is obtained by setting consecutive arbitrary points such that the sums of distances from these two fixed points to the respective arbitrary points on the inner surface of the cavity 51 become equal. Note that the two fixed points may overlap each other. In this case, the inner surface of the cavity 51 becomes a spherical surface. Alternatively, when the two fixed points are sufficiently separated from each other, the inner surface of the cavity 51 becomes a paraboloid of revolution. In either of the cases, the cavity 51 according to this embodiment has a shape with a tangent rotation angle θ being always 0° or more without any surface recessed inwardly.

The cavity 51 is laid out one-sidedly near the distal end separated from the bottom surface 52 of the optical element 50 along the central axis C. The inner surface of the cavity 51 is provided with a diffusing surface 51a by white coating or sandblasting. In this case, the optical element 50 is divided along a plane including the central axis C. After the diffusing surface 51a is formed in the cavity 51, the divided elements are bonded to each other. Alternatively, when a 3D printer is to be used, the cavity 51 is filled with a support member (e.g., white acrylic).

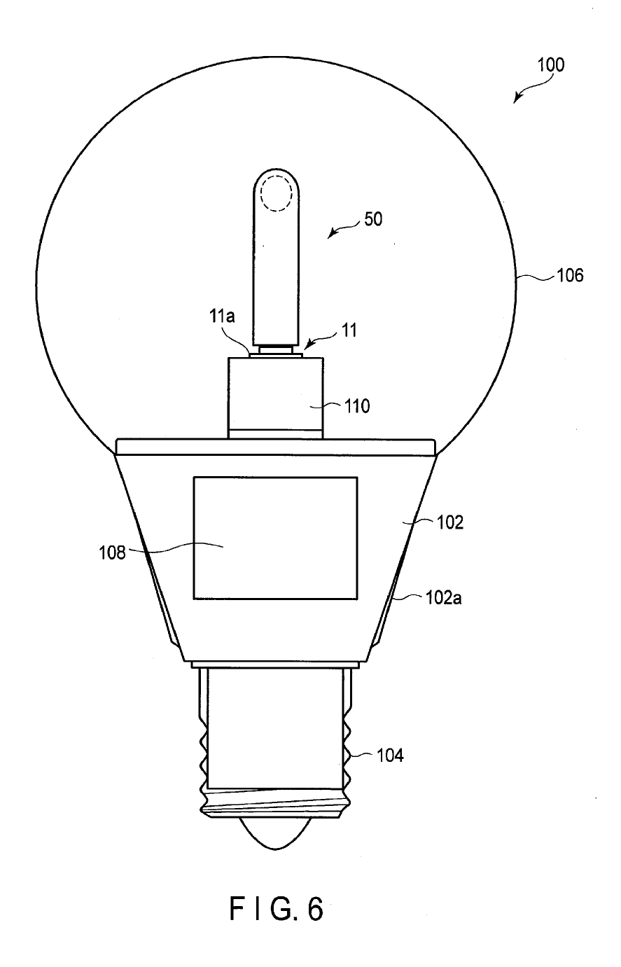

As shown in FIG. 6, the optical element 50 is incorporated in a light bulb 100 as an example of an illumination apparatus. Although not described here, an optical element according to another embodiment can also be incorporated in the light bulb 100, as shown in FIG. 6.

The light bulb 100 includes a metal heat dissipation housing 102, a cap 104 to be electrically connected to a socket in a ceiling (not shown) or the like, an almost spherical transparent globe 106 covering the optical element 50, a lighting circuit 108 which lightens a light-emitting element 11 by feeding power to it, and the optical element 50. The light-emitting element 11 includes a substrate 11a and is mounted on an upper surface 110a of a substrate support 110 with the reverse surface of the substrate 11a being in contact with the upper surface 110a. The lighting circuit 108 is connected to the light-emitting element 11 and the cap 104 via wirings (not shown). The lower end side (not shown) of the substrate support 110 is thermally connected to the heat dissipation housing 102. The optical element 50 is mounted with the bottom surface 52 facing the light-emitting surface of the light-emitting element 11. The light bulb 100 is attached to, for example, a socket in a ceiling while the posture in FIG. 6 is reversed, with the cap 104 facing up.

The heat dissipation housing 102 has one end (the lower end in FIG. 6) to which the cap 104 is connected and the other end (the upper end in FIG. 6) to which the globe 106 is attached. The 102, the cap 104, and the globe 106 have axes overlapping the tube axis of the light bulb 100. The optical element 50 is attached such that its central axis C coincides with the tube axis of the light bulb 100.

The heat dissipation housing 102 has an outer shape which is an almost circular truncated cone shape whose diameter gradually increases from one end to the other end. The heat dissipation housing 102 is thermally connected to the light-emitting element 11 via the substrate support 110 and functions to dissipate the heat of the light-emitting element 11 to the outside of the heat dissipation housing 102. For this purpose, the heat dissipation housing 102 may include a plurality of heat dissipation fins on an outer circumferential surface 102a.

The shape of the globe 106 is not limited to the spherical shape shown in FIG. 6 and may be a chandelier shape.

A light beam group emitted from the light-emitting surface of the light-emitting element 11 enters the bottom surface 52 of the optical element 50. The light beam group entering the bottom surface 52 propagates in the optical element 50 via a light guide portion 2 and a scattering portion 3. The light propagating in the optical element 50 is collected and scattered by the diffusing surface 51a of the cavity 51. As a consequence, illumination light having a distribution angle equivalent to that of an incandescent light bulb emerges. That is, using the optical element 50 according to this embodiment can make the center of the globe 106 shine, thereby providing a retrofitting effect.

As described above, like the first embodiment, the second embodiment can provide the optical element 50 which can efficiently cause light with a wide light distribution to emerge, and can effectively dissipate the heat of the light-emitting element 11.

### Third Embodiment

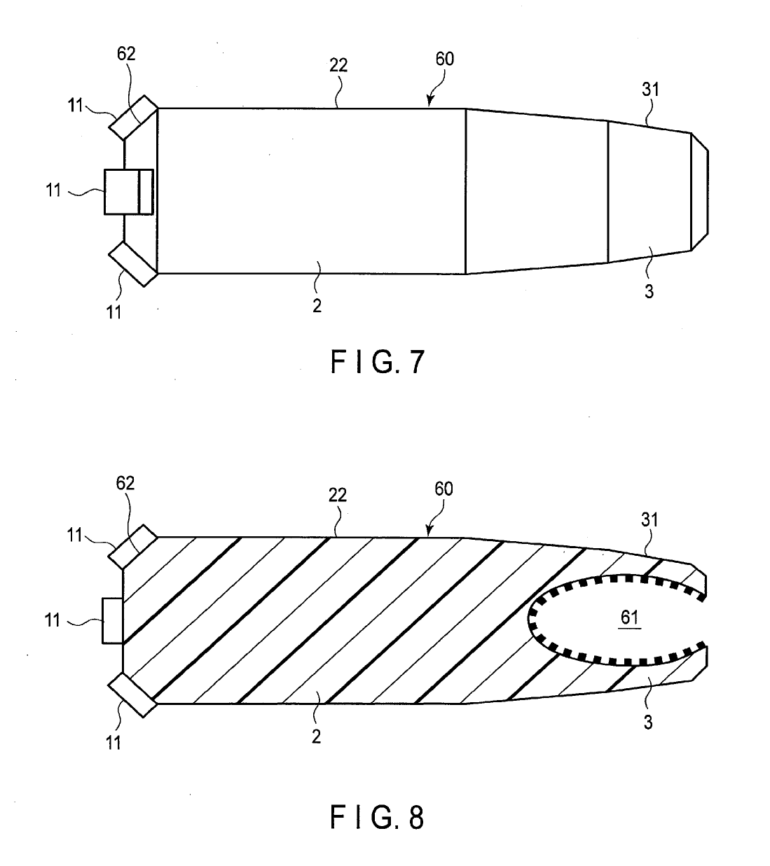

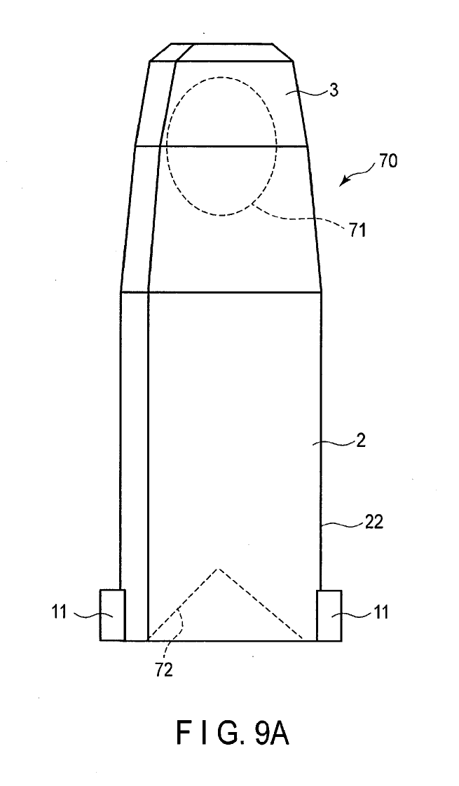

An optical element 60 according to the third embodiment will be described next with reference to FIGS. 7 and 8. In this embodiment as well, the same reference numerals denote constituent elements having the same functions as those in the first embodiment, and a detailed description of them will be omitted.

The optical element 60 has, on one end side, an annular inclined surface 62 facing a plurality of light-emitting elements 11. The inclined surface 62 is inclined with respect to a plane perpendicular to a central axis C of the optical element 60. The plurality of light-emitting elements 11 are arranged at equal intervals along the circumferential direction of the inclined surface 62, with the light-emitting surfaces facing the inclined surface 62. For this reason, the light-emitting surface of each light-emitting element 11 is not perpendicular to the central axis C of the optical element 60. That is, the light-emitting surfaces of the respective light-emitting elements 11 are three-dimensionally laid out instead of being arranged on the same plane.

Three-dimensionally arranging the respective light-emitting elements 11 can make the apparatus arrangement compact and increase the degree of freedom in design. In addition, this makes it possible to arrange the plurality of light-emitting elements 11 in a dispersed pattern, thereby suppressing concentration of heat sources and improving the heat dissipation characteristics.

In addition, the optical element 60 according to this embodiment has a cavity 61 open on the other end side separated from the light-emitting elements 11. The inner surface of the cavity 61 is provided with a diffusing surface 61a. The inner surface shape of the cavity 61 is also formed so as to make a tangent rotation θ described above always 0° or more. For this reason, this embodiment can provide the same effects as those of the first and second embodiments described above.

Although not shown, the inner surface of the cavity open on the other end side of the optical element as in this embodiment may gradually expand toward the opening. This makes it possible to perform mold releasing upon molding an optical element, thereby facilitating manufacturing an optical element.

### Fourth Embodiment

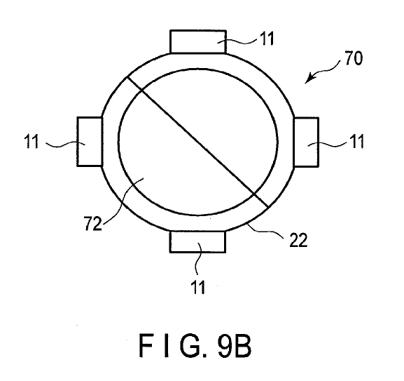

An optical element 70 according to the fourth embodiment will be described next with reference to FIGS. 9A and 9B. In this case as well, the same reference numerals denote constituent elements having the same functions as those in the above embodiments, and a detailed description of them will be omitted.

The optical element 70 has a conical surface 72 on one end side along a central axis C. The conical surface 72 is formed by recessing the bottom surface of the optical element 70. The conical surface 72 is formed into a mirror surface by depositing aluminum on the surface. A plurality of light-emitting elements 11 are provided so as to face the conical surface 72. That is, each light-emitting element 11 is provided so as to be oriented such that the light-emitting surface faces the light-emitting surface of the side surface 22 of the optical element 70.

A light beam group emitted from the light-emitting surface of each light-emitting element 11 is reflected by the conical surface 72 and propagates to the light guide portion 2 to be guided to a cavity 71. The cavity 71 has an inner surface shape similar to that of the cavity 51 according to the second embodiment. Therefore, the optical element 70 is also formed upon being temporarily divided along a plane including the central axis C.

As described above, this embodiment can also provide effects similar to those of the first to third embodiments, thus efficiently causing light with a wide light distribution to emerge.

Several embodiments of the present invention have been described above. However, these embodiments are presented merely as examples and are not intended to restrict the scope of the invention. These embodiments can be carried out in various other forms, and various omissions, replacements, and alterations can be made without departing from the spirit of the invention. The embodiments and their modifications are also incorporated in the scope and the spirit of the invention as well as in the invention described in the claims and their equivalents.

### REFERENCE SIGNS LIST

1 . . . cavity
2 . . . light guide portion
3 . . . scattering portion
3a . . . diffusing surface
10, 50, 60, 70 . . . optical element
11 . . . light-emitting element
L . . . boundary line
V1, V2 . . . tangent vector
θ . . . tangent rotation angle

1. An optical element formed from a transparent material, having a rotationally symmetrical shape with respect to a central axis, and including a light guide portion having one end on a light source side along the central axis and a scattering portion provided on the other end of the light guide portion along the central axis, comprising
a cavity inside the optical element,
wherein an inner surface of the cavity located in the scattering portion has a shape in which a boundary line of the cavity along which a plane including the central axis intersects the inner surface includes a curve portion expanding toward the exterior of the optical element, and when an origin is set in the cavity, a clockwise direction around the origin along the boundary line is set as a positive direction, a first tangent vector is set at a first point on the boundary line, and a second tangent vector is set at a second point adjacent to the first point in the positive direction, an angle defined by the second tangent vector with respect to the first tangent vector with the clockwise direction being a positive direction is not less than 0°.

2. The optical element of claim 1, further comprising:
a bottom surface located on a one end side of the central axis; and
a side surface which is continuous with the bottom surface and extends along the central axis,
the side surface having a shape tapered toward the other end side of the central axis.

3. The optical element of claim 1, wherein the cavity is arranged inside the tapered shape.

4. The optical element of claim 1, wherein at least an inner surface of the cavity located in the scattering portion includes a diffusing surface configured to scatter light.

5. The optical element of claim 1, wherein the cavity accommodates a scattering member configured to scatter light.

6. The optical element of claim 2, wherein the cavity has an opening communicating with the bottom surface, and the inner surface of the cavity has a shape gradually expanding along the central axis toward the opening.

7. The optical element of claim 1, wherein the cavity comprises an enclosed space closed inside the optical element.

8. The optical element of claim 7, wherein an inner surface shape of the cavity comprises an ellipsoid of revolution obtained such that sums of distances from each of two fixed points set in the cavity to arbitrary points on the inner surface become equal.

9. The optical element of claim 8, wherein the inner surface shape of the cavity comprises a spherical surface with the two fixed points overlapping each other.

10. The optical element of claim 2, wherein the cavity has an opening on the other end side separated from the bottom surface of the optical element and an inner surface with a shape gradually expanding along the central axis toward the opening.

11. An illumination apparatus comprising:
an optical element defined in claim 1; and
a light source having a light emitting surface,
the light source being arranged such that the light emitting surface faces a bottom surface of the optical element located on the one end side of the light guide portion.

12. The illumination apparatus of claim 11, further comprising a substrate on which the plurality of light sources are circularly arranged,
wherein the plurality of light sources are arranged on the substrate such that the light emitting surface of each of the light sources faces the bottom surface of the optical element.

13. The illumination apparatus of claim 12, wherein the bottom surface of the optical element includes an inclined surface inclined with respect to a plane perpendicular to the central axis, and
the plurality of light sources are arranged such that the light emitting surface of each of the light sources faces the inclined surface.

14. An illumination apparatus comprising:
an optical element defined in claim 1;
a light source having a light emitting surface; and
a globe which covers the light source and the optical element and transmits light,
wherein the light source is arranged such that the light emitting surface faces a bottom surface of the optical element located on the one end side of the light guide portion.
